(19) United States
(12) Patent Application Publication
(10) Pub. No.: US 2011/0219988 A1
(43) Pub. Date: Sep. 15, 2011

(54) Adjustable table and method

(76) Inventor: Jim O. Stephens, Hilton Head Island, SC (US)

(21) Appl. No.: 12/661,135

(22) Filed: Mar. 11, 2010

(51) Int. Cl. A47B 13/08; A47B 1/10; A47B 9/00; B23P 11/00

(52) U.S. Cl. 108/6; 108/137; 108/138; 29/525.01

(57) ABSTRACT

A table having adjustment means is provided, wherein the work surface may be raised or lowered, widened or narrowed, tilted at a desired angle, or so that the shape may be altered. The adjustable table utilizes a series of slots, holes and bolts, allowing the components of the table to slide in various directions, providing multi-dimensional adjustment capabilities by simply loosening the attachment means (preferably bolts and nuts), sliding the components to their desired position, and then tightening the attachment means to fix the components in that position.

### BACKGROUND OF THE INVENTION

The present invention relates generally to tables that are adjustable in multiple directions. More specifically, the present invention includes a table that may be adjusted with respect to its height and width, and which may be adjusted angularly, as desired. Additionally, the present invention includes a method for providing adjustable means for tables and other furniture pieces.

Heretofore, a variety of adjustable tables and work platforms have been developed and commercialized. Height adjustable tables are well known, and tables having width adjusting means are also commercially available. Various tables have been developed to provide width adjusting means, including dining room style tables that may be separated so that an additional section, or “leaf”, may be affixed within the gap. Other tables include hinged platforms on one or more sides, which may be locked into a horizontal position in order to provide additional work space, and which may be folded into a downward vertical position when not in use. Still other tables or work platforms allow a user to adjust the angle of the work space, such as draftsman's desks. However, none of the prior art includes a table having slots strategically positioned within the structure, so that the table may be raised and lowered, tilted, widened or narrowed, and further which allow the table to change its shape.

It would be desirable to provide a table having multiple adjustment means, so that the table could be adapted for various uses and formed into multiple desired configurations. Such an arrangement could be manufactured in varying sizes, so that it could be useful as a work platform as a standard sized table, or as a lap desk that may be positioned over a user's lap while the user is sitting in a chair or lying on a bed, for instance.

### SUMMARY OF THE INVENTION

The present invention includes a table having adjustment means, so that the work surface may be raised or lowered, widened or narrowed, tilted at a desired angle, or so that the shape may be altered. The multi-dimensional adjustability of the table is based on an angular slot concept. If two flat planar components, such as boards, are positioned one on top of the other in an overlying position, and each component includes a slot (wherein the slots are not running in a parallel direction), and a bolt (or the like) is used to connect the components by passing through the slots, then the position of the components may be moved and adjusted with respect to each other with a high degree of freedom in multiple directions. The adjustable table utilizes a series of slots, holes and attachment means, allowing the components of the table to slide in various directions, providing multi-dimensional adjustment capabilities by simply loosening the attachment means (preferably bolts and nuts), sliding the components to their desired position, and then tightening the attachment means to fix the components in that position.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of an adjustable table in accordance with the present invention;

FIG. 2 is a perspective bottom view of one embodiment of an adjustable table in accordance with the present invention;

FIG. 3 is a perspective view of an adjustable table in a raised position in accordance with the present invention;

FIG. 4 is a perspective view of an adjustable table in a tilted position, in accordance with the present invention;

FIG. 5 is a perspective view of an adjustable table with the sliding platforms in an extended linear position, in accordance with the present invention;

FIG. 6 is a perspective view of an adjustable table with the sliding platforms in an extended, angular position, in accordance with the present invention; and

FIG. 7 is an exploded view of an adjustable table in accordance with the present invention.

### DETAILED DESCRIPTION OF THE INVENTION

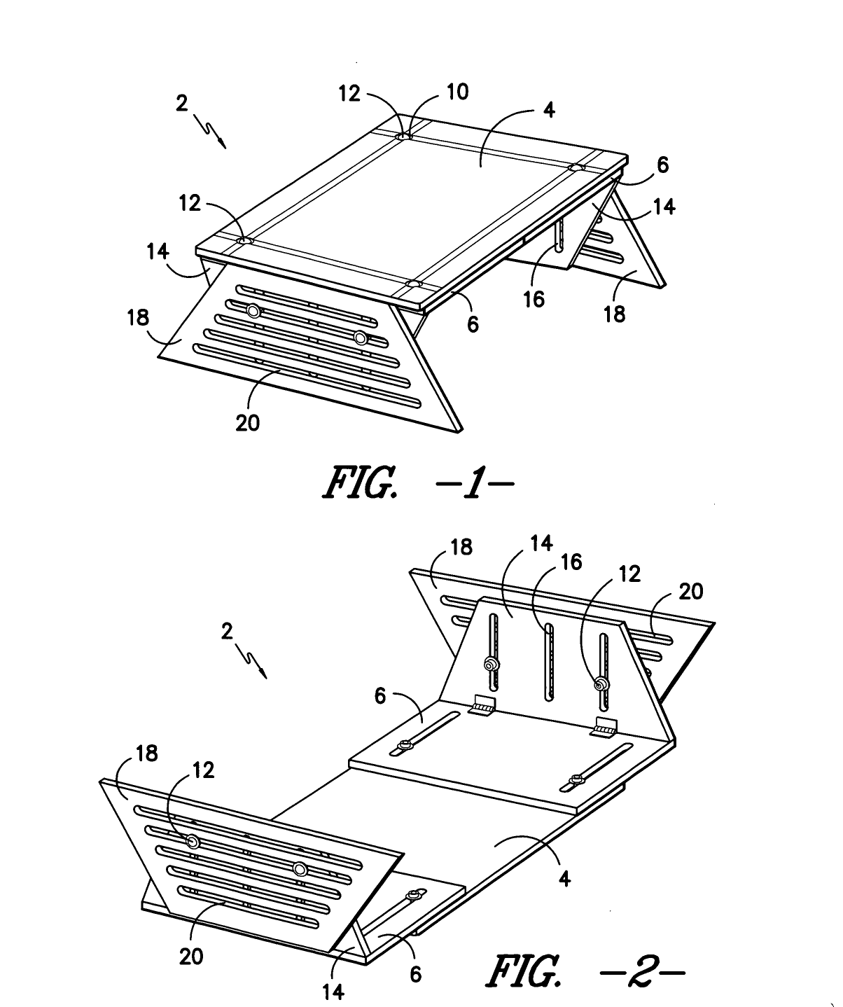

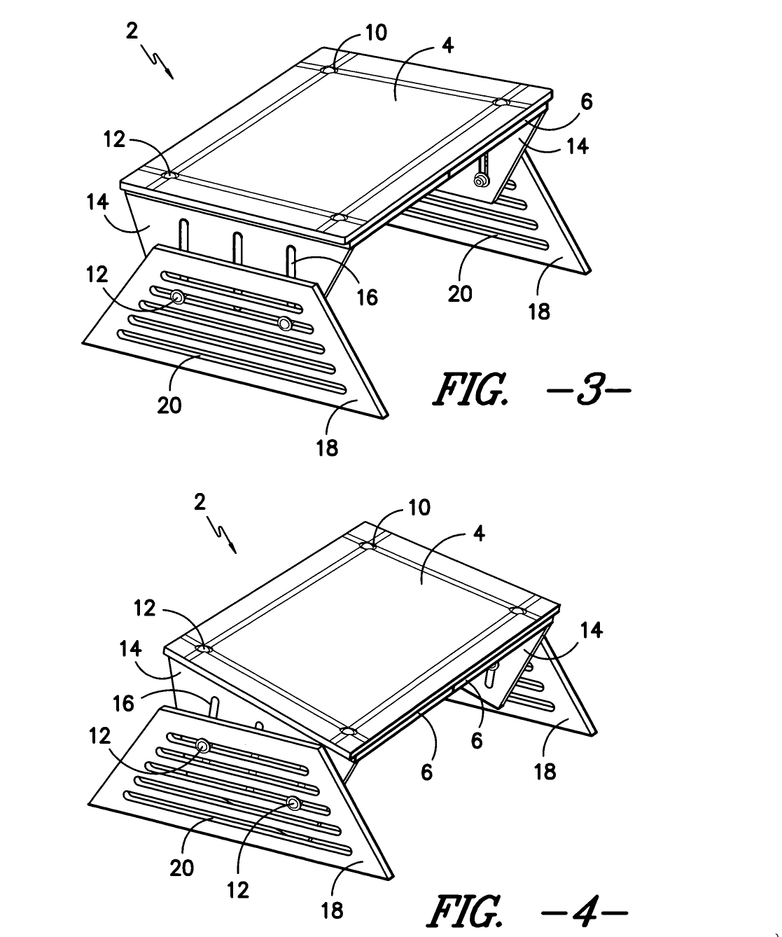

A first embodiment of the adjustable table is shown in FIG. 1. The table 2 includes an upper work surface 4, and a pair of sliding panels 6 positioned horizontally, below and in contact with the upper work surface 4. The sliding panels 6, in a preferred embodiment, are each approximately half the size of the upper work surface 4, so that when they are adjacent one another, they sit neatly beneath the upper work surface 4. Each sliding panel 6 includes a lateral slot 8 at a front side, and a second lateral slot 8 at a back side. The upper work surface 4 may include four holes 10, wherein each hole 10 is located adjacent a corner thereof. Attachment means 12, such as nuts and bolts or other suitable means, are used to attach the upper work surface 4 to the sliding panels 6. The bolts 12 extend downwardly through the holes 10 in the upper work surface 4 and through the slots 8 on the sliding panels 6, and the nut is screwed onto the bolt 12 tightly enough to fix the sliding panels 6 to the underside of the upper work surface 4 through frictional engagement. In this manner, the attachment means 12 may be loosened up on either or both sides of the upper work surface 4, and the sliding panels 6 may slide outwardly to a desired position, effectively widening the table 2 and providing additional work space.

Each sliding panel 6 also includes a fixed vertical support 14 extending downwardly along the outer sides thereof. The fixed vertical support 14 may be permanently attached in a vertical orientation with respect to the sliding panels 6, or alternatively, the fixed vertical support 14 may be attached by a hinge, so that it may be locked into a vertical position when in use, and folded into a horizontal position underneath the sliding panels 6 when not in use. Each fixed vertical support 14 includes, in a preferred embodiment, a series of vertical slots 16. A sliding vertical support 18 is attached to each fixed vertical support 14. Each sliding vertical support 18 includes, in a preferred embodiment, a series of horizontal slots 20. Bolts 12, or other attachment means, extend through the vertical slots of the fixed vertical support, and through the horizontal slots of the sliding vertical support. This arrangement allows the height and angle of the table 2 to be adjusted as desired.

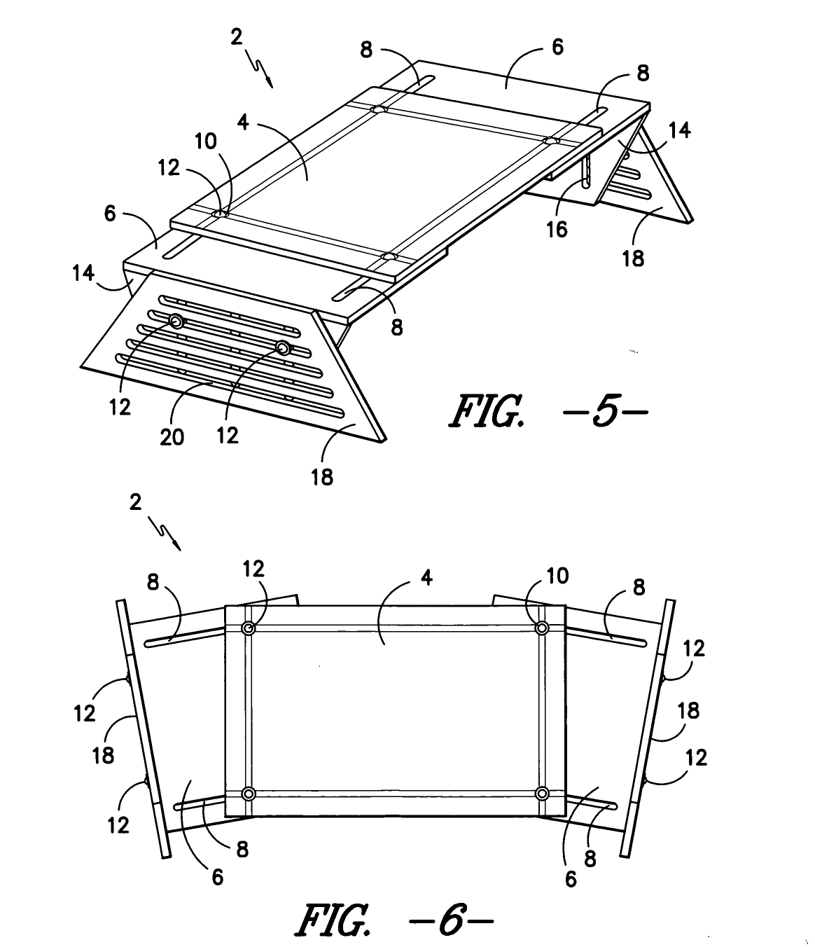

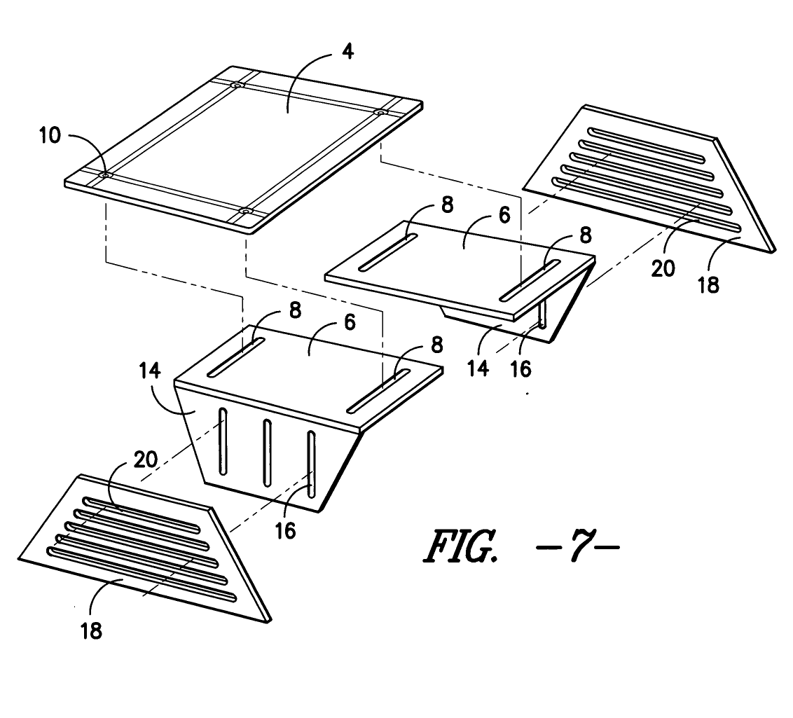

FIGS. 3-6 show the table 2 in several different configurations. FIG. 3 shows the table in a raised position. It should be noted that the sliding vertical supports 18 on each side of the table 2 may each move in a horizontal direction, as well as in a vertical direction, which allows for a 360 degree range of freedom. FIG. 4 shows the table 2 in a tilted position, where the rear portion of the upper work surface 4 is raised to a level above the front portion of the upper work surface 4. This arrangement is particularly useful for a person who is reading or working, while sitting up in a bed. FIG. 5 shows the table 2 with the sliding panels 6 in an extended, linear position, thereby effectively increasing the width of the table 2 and providing additional work space. FIG. 6 shows the table 2 with the sliding panels 6 in an extended, angular position in which the sliding panels form an obtuse angle with respect to a longitudinal axis of the upper work surface 4.

Another optional embodiment of the adjustable table includes an upper work surface directly attached to a pair of fixed vertical supports, one on each lateral side of the upper work surface. The sliding vertical supports are attached to the fixed vertical supports, as set forth above. In this embodiment, the adjustable table does not include the width adjusting means, but does allow the height and angular tilt of the upper work surface to be adjusted. Similarly, yet another embodiment of the adjustable table includes the upper work surface and the sliding panels as set forth above, which include fixed vertical supports, but does not include the sliding vertical support member. This embodiment allows width adjustments as described above, but is not adjustable with respect to height or angular tilt of the upper work surface.

It is contemplated that the adjustable table may be made from wood, plastic, or any other suitable material. It is further contemplated that the components of the table may be manufactured using an injection molding process. Alternate embodiments may include slots that are curved or specially designed to enhance adjustability. Although the drawings show the fixed vertical supports 14 and the sliding vertical supports 18 as each having three slots, it should be understood that more or less slots may be used, as desired. Furthermore, although the components are shown having specific shapes, it should be understood that other shapes may be used. For instance, the upper work surface 4 and the sliding panels 6 may be rectangular as shown, or may have a different shape, as desired. The adjustable table may be made into any desired size. Additionally, it should be appreciated that the method of providing a series of non-parallel slots within overlying flat surface components in order to provide multi-dimensional degrees of freedom for purposes of adjustment may be utilized with respect to other types of furniture,

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An adjustable table comprising:
an upper work surface having a plurality of holes;
a first sliding panel and a second sliding panel, each sliding panel including at least one lateral slot;
attachment means positioned through said holes and said sliding panel slots for attaching said sliding panels to an underside of said upper work surface so that loosening said attachment means allows the sliding panels to slide inwardly toward a center of said upper work surface, or outwardly from said center of said upper work surface, wherein said attachment means may be tightened when said sliding panels are placed into a desired position in order to secure said sliding panels to said upper work surface.

2. The adjustable table set forth in claim 1, further including a pair of fixed vertical supports, each attached to an outer side of said sliding panels.

3. The adjustable table set forth in claim 2, wherein said fixed vertical supports include at least one slot, which extends either horizontally or vertically therein.

4. The adjustable table set forth in claim 3, further including a pair of sliding vertical supports, each said sliding vertical support including at least one slot oriented in a direction perpendicular to said slots on said corresponding fixed vertical support; and
attachment means positioned through said sliding vertical support slot and said fixed vertical support slot for attaching said sliding vertical supports to said fixed vertical supports, so that said sliding vertical supports may be adjusted with a 360 degree of freedom in a vertical plane with respect to said fixed vertical supports, and so that said attachment means may be tightened to secure said sliding vertical supports in a desired position.

5. The adjustable table set forth in claim 3, wherein said attachment means are selected from the group consisting of screws and nuts and bolts.

6. The adjustable table set forth in claim 2, wherein said fixed vertical supports are hingedly attached to said upper work surface, so that each fixed vertical support may be secured in a vertical position when in use, and may folded under said sliding panel when not in use.

7. The adjustable table set forth in claim 1, wherein said each sliding panel includes at least two slots.

8. The adjustable table set forth in claim 2, wherein each said fixed vertical support includes at least two slots.

9. The adjustable table set forth in claim 4, wherein each said sliding vertical support includes at least two slots.

10. An adjustable table comprising:
an upper work surface;
a first and second sliding panel affixed to said upper work surface on an underside thereof, wherein said sliding panels are in sliding relation with said upper work surface, so that they may slide inwardly toward a center of said upper work surface, or may slide outwardly away from said center of said upper work surface, wherein said first and second sliding panels may be fixed in any desired position with respect to said upper work surface.

11. The adjustable table set forth in claim 10, wherein said first and second sliding panels each include adjustable support means allowing height and tilt adjustment of said upper work surface.

12. The adjustable table set forth in claim 10, wherein said sliding panels may slide outwardly either along a straight lateral axis with respect to said upper work surface, or may slide outwardly at an obtuse angle with respect to said lateral axis of said upper work surface.

13. The adjustable table set forth in claim 11, wherein said adjustable support means are pivotally attached to said sliding panels, so that said adjustable support means may be folded underneath said sliding panels when said table is not in use.

14. An adjustable table comprising:
an upper work surface;
a first and second fixed vertical support member, each attached to a lateral underside of said upper work surface;
a pair of sliding support members each slidably attached to one of said fixed vertical support members so that a user may adjust the height and angular tilt of said upper work surface.

15. The adjustable table set forth in claim 14, wherein said fixed vertical supports include at least one slot, which extends either horizontally or vertically therein.

16. The adjustable table set forth in claim 15, wherein said sliding vertical supports includes at least one slot oriented in a direction perpendicular to said slots on said corresponding fixed vertical support.

17. The adjustable table set forth in claim 16, further including attachment means positioned through said sliding vertical support slot and said fixed vertical support slot for attaching said sliding vertical supports to said fixed vertical supports, so that said sliding vertical supports may be adjusted with a 360 degree of freedom in a vertical plane with respect to said fixed vertical supports, and so that said attachment means may be tightened to secure said sliding vertical supports in a desired position.

18. A method of constructing furniture having adjustment means, said method comprising:
providing a first planar component defining a first slot positioned therein;
providing a second planar in an overlying relationship with said first planar component, said second planar component defining a second slot positioned therein; and
attaching said first planar component to said second planar component using attachment means, wherein said attachment means extend through said first slot and said second slot, and wherein said attachment means may be loosened so that said first planar component may be placed into a desired position with respect to said second planar component, and wherein said attachment means may be tightened in order to hold said planar components in said desired position with respect to one another.

19. The method set forth in claim 1, wherein said first slot and said second slot are positioned so that said slots are not in parallel relation with one another.

20. The method set forth in claim 19, wherein said first slot and said second slot are positioned in a substantially perpendicular relation.
